(19) United States
(12) Patent Application Publication
(10) Pub. No.: US 2023/0055916 A1
(43) Pub. Date: Feb. 23, 2023

(54) SELF-SINTERED THERMAL INTERFACE MATERIALS

(71) Applicant: Science Applications International Corporation, Reston, VA (US)

(72) Inventors: John P. Timler, River Ridge, LA (US); Xingcun C. Tong, Bolingbrook, IL (US)

(21) Appl. No.: 17/752,041

(22) Filed: May 24, 2022

Related U.S. Application Data
(63) Continuation-in-part of application No. 17/402,324, filed on Aug. 13, 2021.

(51) Int. Cl. C08K 3/013; C08K 3/105

(52) U.S. Cl. CPC C08K 3/013; C08K 3/105; C08K 2201/011

(57) ABSTRACT

Self-sintering thermal interface material is prepared from a polymer matrix and a filler. The polymer matrix may be a water or hydrogen peroxide or other water-contained solvent solution such as ammonia or alcohol containing a water soluble resin and fumed silica or an alcohol or other solvent solution containing at least one water insoluble resin and fumed silica. The filler contains i) gallium alkali metal or gallium metal, ii) one or more micro/nano-sized metallic fillers, and iii) dielectric fillers.

### CROSS-REFERENCE TO RELATED APPLICATIONS

This application is a continuation-in-part of U.S. Ser. No. 17/402,324, filed Aug. 13, 2021, hereby incorporated by reference in its entirety.

### GOVERNMENT LICENSE RIGHTS

This invention was made with Government support under Contract No. N0016421F3020 awarded by the United States Navy. The Government has certain rights in this invention.

### BACKGROUND

Thermal interface materials (TIMs) serve to fill a gap between two adjoining surfaces. TIMs are often composed of metal pastes, metal solders, resilient sheets, mechanically compliant pads, and polymers typically composited with filler materials. Each type of TIM has its own strengths and weaknesses. Resiliency, for example, helps the conformability. The performance of a thermal interface material is enhanced by conformability of the interface material to the topography of the mating surfaces, since the air residing in the valleys in the surface topography is thermally insulating and should be displaced by the interface material.

Thermal conductivity may be measured by Watts per meter-Kelvin “W/m-K.” Metal TIMs can achieve a high thermal conductivity over 86 W/m-K—that of indium—and an interfacial resistance of 0.005 K cm²/W. However, they are marred by reliability problems and are more expensive than alternatives. A metal TIM suffers from poor lifespan performance because it is typically frozen between two surfaces of different coefficients of thermal expansion to each other and to itself. As the temperature of the junction is inevitably varied, disadvantageous thermomechanical stress is inadvertently applied to the TIM, which eventually cracks it, leading to substantially reduced performance. That same thermal expansion mechanism can result in pushing fluid TIMs out of the junction in a process called ‘pumping out.’ This can be very problematic in more modern, permanently fluid metal TIMs because there is a risk of spilling onto electrical components susceptible to electrical shorting failures.

Elastomeric thermal pads TIMs are very spongy and flexible solid pads that push themselves into gaps in the junction due to their resistance to mechanical deformation. The highest thermal conductivity achieved in this class of TIM in industry, is around 60 W/m-K. However, they are usually not adhesive and suffer from large contact resistance, which ultimately leads to a modest overall thermal resistance.

A solid polymer or clay material can be used in the direct encapsulation of less complex semiconductor circuits than modern very large-scale integration (“VLSI”) chips for protection from environmental contaminants. Although chips encapsulated in this manner will typically have fewer heat-producing circuit elements than in VLSI chips, devices of this class can include high-power GaN amplifiers with substantial lifespan sensitivity to operating temperature. The thermal performance of the encapsulation material is an important parameter determining device operating temperatures, analogous to a classic TIM. Consequently, chip encapsulation materials are considered a type of TIM. Encapsulation TIMs are typically even more sensitive to electrical conductivity (EC) due to their direct contact with active circuit elements.

Polymeric TIMs are the most common class of TIMs. These TIMs typically have a polymer matrix in which a highly thermally conductive filler is added to form a composite. This class of TIMs has a higher thermal resistance than metal-based TIMs but benefit from being stable at higher temperatures and substantially simpler to work with, especially when re-application is necessary. To date, these TIMs tend to have a lower thermal conductivity than thermal pads, with a bulk thermal conductivity in industry between 0.5-7.0 W/m-K at high filler concentration, but have much less contact resistance, leading to only slightly better performance.

Polymeric thermal interface materials generally use common polymers such as mineral and silicone oil, epoxy, poly(methyl methacrylate) (PMMA) and polyethylene. The performance of such polymers vary widely.

Many applications require TIMs with electrically insulating properties, and others require electrical conductivities for EMI noise protection, such as TIMs for antenna array in 5G communication systems. Polymer TIMs can vary widely in their electrical conductivity depending primarily on the type, concentration, and morphology of the filler used.

An electrically conductive filler material can be used to fill a polymer TIM up to a certain level—termed the electrical percolation threshold. The percolation theory can be applied to explain the electrically conducting behavior of composites consisting of conducting fillers and insulating matrices. When the conducting filler content is gradually increased, the composite undergoes an insulator-to-conductor transition. The electrical percolation threshold is the critical reinforcement concentration where the composite turns abruptly from insulator to conductor as conductive pathways are formed. During this transition, the electrical conductivity may be increased by orders of magnitude. Orders of magnitude are used to make approximate comparisons. For example, if numbers differ by one order of magnitude, x is about ten times different in quantity than y. If values differ by two orders of magnitude, they differ by a factor of about 100.

Of considerable importance to TIMs, electrical percolation threshold has analogous behavior in thermal conductivity known suitably as thermal percolation threshold. The percolations of these two material parameters are governed by the concentration and morphology of filler material required for large-scale, uninterrupted paths to become opened up from one filler particle to the next. At this point, a low-resistance pathway, be it thermal or electrical, from one end of the TIM to the other becomes available and each respective property enhances substantially. Often a second dielectric filler material with poor electrical conductivity is added to allow the use of a primary, superior thermally conductive but also electrically conductive filler without an unacceptable increase in overall TIM electrical conductivity for electrically insulating TIMs, for instance.

Certain TIMs must be sintered after being applied to a surface. There are many sintering techniques, such as thermal, chemical, electric, and laser sintering, for example, thermal sintering to over 100 degrees Celsius or extended ultraviolet or infrared development. Advanced sintering techniques involve microwave, or laser radiation, xenon flash light, electrical or chemical sintering, and plasma. However, these processes result in extra costs and time after the printing process, and often involve high-cost equipment, require high energy, and/or require complex pre- or post-treatments.

Increases in cooling demand for electronic packaging increased focus within the microelectronics industry on developing high performance thermal solutions. TIMs play a key role in thermally connecting various components of the thermal solutions for computing, information, communication (5G or beyond), energy harvesting, energy storage and lighting technologies. As electronic assemblies become more compact and increase in processing bandwidth, escalating thermal energy has become more difficult to manage. A major limitation is nonmetallic joining using poor thermal interface materials. The interfacial, versus bulk, thermal conductivity of an adhesive is the major loss mechanism and normally accounts for an order magnitude loss in conductivity per equivalent thickness.

### SUMMARY

The following presents a simplified summary in order to provide a basic understanding of the disclosure. The summary is not an extensive overview of the disclosure. It is neither intended to identify key or critical elements nor to delineate the scope of the disclosure. The following summary merely presents some concepts in a simplified form as a prelude to the more detailed description below.

Aspects of the present disclosure relate to self-sintered composite thermal interface materials (TIMs) mechanized by adhesive polymer self-curing. The self-sintered thermal interface materials can be processed and applied at a low to ambient temperatures. After application, the self-sintering TIMs, on reaching a designed trigger temperature (including room temperature), may metallize through a two-step process.

A first step may comprise raising the temperature to the trigger temperature to cause a gallium-alkali metal component to activate and react with water released from a water absorbing gel component. The exothermic reaction between the water and the alkali element creates an intense and highly localized heating effect, which liquefies all metallic components and enhances surface bonding between non-metallic fillers in the TIMs and, on cooling, creates a solid inorganic network that is reinforced by the self-curing of the polymer matrix. Post cooling, the TIM is thermally stable and need not be reflowed with a significant temperature increase (well above 100's of degrees Celsius) or other energetic input.

Alternatively, a first step may comprise raising the temperature to cause a gallium metal component to melt. Upon melting, the gallium metal wets and may react with other fillers in a non-exothermic reaction to enhance the connectivity between adjacent filler particles. A solid inorganic network is created that is reinforced by the self-curing of the polymer matrix. Post cooling, the TIM is thermally stable and need not be reflowed with a significant temperature increase (well above 100's of degrees Celsius) or other energetic input.

### BRIEF DESCRIPTION OF THE DRAWINGS

FIG. 1 shows an example illustrated flow chart of a method of preparing self-sintered dielectric thermal interface materials via exothermic reaction in accordance with aspects of the disclosure.

FIG. 2A depicts thermal expansion versus thermal conductivity of the self-sintered dielectric and conductive thermal interface materials.

FIG. 2B depicts electric field strength versus thermal conductivity of the self-sintered dielectric and conductive thermal interface materials.

FIG. 2C depicts glass transition temperature versus thermal conductivity of the self-sintered dielectric and conductive thermal interface materials.

FIG. 2D depicts electrical resistivity versus thermal conductivity of the self-sintered dielectric and conductive thermal interface materials.

FIG. 2E depicts Young's modulus versus thermal conductivity of the self-sintered dielectric and conductive thermal interface materials.

FIG. 3A depicts self-sintered thermal interface material of Sample 8 in accordance with an aspect of the disclosure.

FIG. 3B depicts self-sintered thermal interface material of Sample 9 in accordance with an aspect of the disclosure.

FIG. 4A depicts a water soluble gel mixed with dielectric and bonder particles prepared in accordance with the flow chart of FIG. 1.

FIG. 4B depicts a water soluble gel mixed with dielectric and bonder particles and Ga-alkali metal prepared in accordance with the flow chart of FIG. 1.

FIG. 4C depicts a self-sintered TIM prepared in accordance with the flow chart of FIG. 1.

### DESCRIPTION

Aspects of the disclosure provide self-sintered thermal interface materials (TIMs) mechanized by adhesive polymer self-curing, liquid metal-thermal filler sintering, and exothermic reaction between alkali metal and water constituents. TIMs may be formulated for a broad range of electrically conductive (electromagnetic interference (EMI) noise protection) and dielectric (semi-conductive or electrical insulation) thermal interface materials.

The self-sintered TIMs can be processed and applied at a low temperature or ambient atmosphere, providing a wide ranges of tailored properties including extremely low thermal impedance, ultrahigh thermal conductivity, good conformability with minimum thermal expansion stress when joining two contact surfaces, great adhesion, and controlled sensitivity to moisture and temperature changes for different service life applications. By eliminating elevated temperature sintering, optical/ultra-violet curing, and/or pressure requirements associated with present common thermal interface materials, the self-sintered thermal interface materials provide low cost and good manufacturability advantages.

Aspects of the disclosure relate to composition formulations, fabrication processes, and suitable application scenarios of self-sintered thermal interface materials.

Electrically Conductive TIMs

Electrically conductive self-sintered thermal interface materials formed by non-exothermic reaction, which are sensitive to water/moisture or insensitive to water/moisture, may be prepared with a polymer matrix and fillers containing gallium metal as shown in, for example, Table I below. In particular, the gallium metal will melt when the temperature is increased to above room temperature.

TABLE I

| | | Thermal | Adhesion | Water | | |
|---|---|---|---|---|---|---|
| Polymer | | Conductivity | to | moisture | | |
| Matrix | Filler | (W/m-K) | Substrate | sensitivity | MFRG | Application |
| (3-20) wt. % | (5-35) | ≥60-100 | Strong | High | Simple | Anti-temper |
| WSR + | wt. % liquid | | | | | or easy to |
| (0-10) wt. % | metal Ga + | | | | | repair; |
| Fumed silica | (30-95) | | | | | electrical |
| water/H₂O₂ | wt. % | | | | | connectivity; |
| solution | micro/nano | | | | | EMI noise |
| | metallic | | | | | protection |
| | fillers | | | | | |
| (0-30) wt. % | (5-35) | ≥60-100 | Strong | Low to | Simple | Long service |
| WSR + (65- | wt. % liquid | | | none | | life under |
| 100) wt. % | metal Ga + | | | | | water or high |
| WIR + (0-10) | (30-95) | | | | | humidity |
| wt. % Fumed | wt. % | | | | | atmosphere; |
| silica + | micro/nano | | | | | electrical |
| (0-5) wt. % | metallic | | | | | connectivity; |
| KOH Alcohol | fillers | | | | | EMI noise |
| solution | | | | | | protection |
| (70-91% | | | | | | |
| Isopropyl) | | | | | | |

Electrically conductive self-sintered thermal interface materials formed by exothermic reaction, which are sensitive to water/moisture or insensitive to water/moisture, may be prepared with a polymer matrix and fillers containing gallium alkali metal as shown in, for example, Table II below. In particular, the gallium alkali metal will react with water when the temperature is raised above the eutectic reaction temperature of the gallium alkali metal.

TABLE II

| | | Thermal | Adhesion | Water | | |
|---|---|---|---|---|---|---|
| Polymer | | Conductivity | to | moisture | | |
| Matrix | Filler | (W/m-K) | Substrate | sensitivity | MFRG | Application |
| (3-20) wt. % | (5-35) | ≥60-120 | Strong | High | Complex | Anti-temper |
| WSR + | wt. % Ga- | | | | | or easy to |
| (0-10 ) wt. % | alkali metal + | | | | | repair; |
| Fumed silica | (30-95) | | | | | electrical |
| water/H₂O₂ | wt. % | | | | | connectivity; |
| solution | micro/nano | | | | | EMI noise |
| | metallic | | | | | protection |
| | fillers | | | | | |
| (0-30) wt. % | (5-35) | ≥60-120 | Strong | Low to | Complex | Long service |
| WSR + (65- | wt. % Ga- | | | none | | life under |
| 100) wt. % | alkali metal + | | | | | water or high |
| WIR + (0-10) | (30-95) | | | | | humidity |
| wt. % Fumed | wt. % | | | | | atmosphere; |
| silica + | micro/nano | | | | | electrical |
| (0-5) wt. % | metallic | | | | | connectivity; |
| KOH Alcohol | fillers | | | | | EMI noise |
| solution | | | | | | protection |
| (70-91% | | | | | | |
| Isopropyl) | | | | | | |

The thermal conductivity of self-sintered electrically conductive TIMs can be 60-100 W/m-K or more.

Dielectric TIMs

Dielectric self-sintered thermal interface materials formed by non-exothermic reaction, which are sensitive to water/moisture or insensitive to water/moisture, may be prepared with a polymer matrix and fillers containing gallium metal as shown in, for example, Table III below. In particular, the gallium metal will melt when the temperature is increased to above room temperature.

TABLE III

| | | Thermal | Adhesion | Water | | |
|---|---|---|---|---|---|---|
| Polymer | | Conductivity | to | moisture | | |
| Matrix | Filler | (W/m-K) | Substrate | sensitivity | MFRG | Application |
| (3-20) wt. % | (5-35) wt. % | ≥160-200 | Strong | High | Simple | Anti-temper |
| WSR + | liquid metal | | | | | or easy to |
| (0-10) wt. % | Ga + (5-15) | | | | | repair; |
| Fumed silica | wt. % | | | | | electrical |
| water/H₂O₂ | micro/nano | | | | | insulation |
| solution | metallic | | | | | |
| | fillers + | | | | | |
| | (10-90) wt. % | | | | | |
| | dielectric | | | | | |
| | fillers | | | | | |
| (0-30) wt. % | (5-35) wt. % | ≥160-200 | Strong | Low to | Simple | Long service |
| WSR + (65- | liquid metal | | | none | | life under |
| 100) wt. % | Ga + (5-15) | | | | | water or high |
| WIR + (0-10) | wt. % | | | | | humidity |
| wt. % Fumed | micro/nano | | | | | atmosphere; |
| silica + | metallic | | | | | electrical |
| (0-5) wt. % | fillers + | | | | | insulation |
| KOH Alcohol | (10-90) | | | | | |
| solution | wt. % | | | | | |
| (70-91% | dielectric | | | | | |
| Isopropyl) | fillers | | | | | |

Dielectric self-sintered thermal interface materials formed by exothermic reaction, which are sensitive to water/moisture or insensitive to water/moisture, may be prepared with a polymer matrix and fillers containing gallium alkali metal as shown in, for example, Table IV below. In particular, the gallium alkali metal will react with water when the temperature is raised above the eutectic reaction temperature of the gallium alkali metal.

TABLE IV

| | | Thermal | Adhesion | Water | | |
|---|---|---|---|---|---|---|
| Polymer | | Conductivity | to | moisture | | |
| Matrix | Filler | (W/m-K) | Substrate | sensitivity | MFRG | Application |
| (3-20) wt. % | (5-35) wt. % | ≥160-220 | Strong | High | Complex | Anti-temper |
| WSR + | Ga-alkali metal + | | | | | or easy to |
| (0-10) wt. % | (5-15) wt. % | | | | | repair; |
| Fumed silica | micro/nano | | | | | electrical |
| water/H₂O₂ | metallic | | | | | insulation |
| solution | fillers + | | | | | |
| | (10-90) wt. % | | | | | |
| | dielectric | | | | | |
| | fillers | | | | | |
| (0-30) wt. % | (5-35) wt. % | ≥160-220 | Strong | Low to | Complex | Long service |
| WSR + (65- | Ga-alkali metal + | | | none | | life under |
| 100) wt. % | (5-15) wt. % | | | | | water or |
| WIR + (0-10) | micro/nano | | | | | high |
| wt. % Fumed | metallic | | | | | humidity |
| silica + | fillers + | | | | | atmosphere; |
| (0-5) wt. % | (10-90) wt. % | | | | | electrical |
| KOH Alcohol | dielectric | | | | | insulation |
| solution | fillers | | | | | |
| (70-91% | | | | | | |
| Isopropyl) | | | | | | |

The thermal conductivity of self-sintered dielectric TIMs can be 160-200 W/K or more.

Exothermic Reaction: To prepare an electrically conductive TIM via exothermic reaction, the filler may contain 5-35 wt. % Ga-alkali metal and 30-95 wt. % micro/nano-sized metallic fillers. To prepare a dielectric TIM via exothermic reaction, the filler may contain 5-35 wt. % Ga-alkali metal, 5-15 wt. % micro/nano-sized metallic fillers, and 10-90 wt. % dielectric fillers. A polymer matrix containing water is mixed with the filler. An exothermic reaction results when the temperature is raised to above the eutectic reaction temperature of the gallium alkali metal.

Non-Exothermic Reaction: To prepare an electrically conductive TIM with a non-exothermic reaction, the filler may contain 5-35 wt. % gallium metal and 30-95 wt. % micro/nano-sized metallic fillers. To prepare a dielectric TIM with non-exothermic reaction, the filler may contain 5-35 wt. % gallium metal, 5-15 wt. % micro/nano-sized metallic fillers, and 10-90 wt. % dielectric fillers. A polymer matrix and filler is combined. Upon increasing the temperature to above room temperature, the gallium metal melts and reacts with other components.

Filler Materials

Filler materials may have physical dimensions small enough so that a consistent mixture may be formed within the TIM. The micro-/nano-sized conductive fillers may provide electrical and/or thermal conductivities. Conductive fillers may include, for example, nanoparticles, nanowires/whiskers, and/or micron size particles that are highly conductive. Micro-/Nano-sized dielectric fillers may be used to provide high thermal conductivities such as include boron nitride (BN), aluminum nitride (AlN), Al₂O₃, BeO, SiC, Si, diamond, graphite, carbon nanotubes, few-layer graphene (FLG) and hybrids comprising them, such as SiC/diamond. Micro/nano-sized metallic fillers may be used for electrically conductive TIMs or as a bonder for dielectric TIMs to enhance adhesion and bonding between dielectric fillers such as silver, copper, aluminum, gold, zinc, nickel; or their alloys; or a combination of them.

In general, particle sizes of micro/nano-sized metallic fillers may range from 20 nm to 2000 μm. The particle size is usually from 100 nm to 100 μm due to the combined considerations of material processing cost, performance, and easy operation. The minimum particle size may be as low as 4 nanometers or even lower, but at least 20 nm may be more common for commercial applications, mainly due to the consideration of material processing cost and operation difficulty.

Gallium

Gallium metal melts just above room temperature (˜29.8° C.) and can be supercooled down to about 15° C. (still keeping liquid state). Gallium metal can be added as a liquid or solid but is easily melted by raising the temperature above room temperature. Thus the gallium metal melts without an exothermic reaction (i.e. a non-exothermic reaction.) Components within the mixture are wetted or reacted with liquid gallium metal (in a non-exothermic reaction) to enhance the connectivity between filler particles.

Gallium-alkali metal (aluminum for example) based low melting point alloys may be used to provide non-oxidized metal (fresh aluminum for example) for exothermic water reaction to trigger self-sintering and may be used for liquid metal fusion bonding for metallic binders and dielectric fillers. The gallium based alloy is also helpful to improve adhesion performance or bonding strength between the substrates.

The gallium-alkali metal alloy has a low melting point and provides non-oxidized metal for exothermic water reaction to trigger self-sintering and liquid metal fusion. The exothermic reaction provides the heat to allow the conductive fillers to melt and form liquid metal. The liquid metal can flow to fill voids and modify connectivity of the conductive network to enhance electrical and thermal conductivities. The resulting concentration and distribution of the liquid metal can be tuned to improve flexibility and stretchability. The gallium-alkali alloy may also improve adhesion performance or bonding strength between substrates.

The melting point range of the gallium-alkali metal may be −15° C. to 300° C. Commercially, the melting point of low melting alloys is usually below 150° C. In aspects described herein, the melting point can be below 85° C., or around room temperatures (e.g. 23 to 35° C.), especially for some polymer substrates with low glass transition temperatures.

The gallium-alkali metal generally contains 1-50 wt % alkali metal and additional elements, with a melting point range of −15° C. to 300° C. Examples of the gallium-alkali metal alloys include Ga—Al, Ga—AlTiC, Ga—Al—Ti—B, Ga—Mg, Ga—Zn, Ga—Fe, Ga—Li, Ga—K, Ga—Ba, Ga—Ca, and Ga—Na with or without a combination of other elements, such as In, Sn, Ti, B, C, Ag, Cu, Fe, Si, Pb, Zn, Ni, Cr, Bi, and rare earth elements etc.

Polymer Compositions

TIMs may be formulated from water-soluble resin (WSR), water-insoluble resin (WIR), or both as a matrix, to provide the desired properties. Properties may range from, for example, water/moisture sensitive to completely insensitive, and opaque to high optical transparency. The TIMs may be formulated for other properties, such as anti-temper or easy to repair, long service life under water or high humidity atmosphere, high electrical connectivity or insulation, and EMI noise protection.

Water Soluble Resins

Suitable water-soluble resins include water soluble poly(ethylene oxide). For instance, water-soluble poly(ethylene oxide) solution gel functions as a binder and suspending supporter for dielectric fillers, bonding additives, and gallium-alkali metal based low melting point alloys during molding/patterning/printing and provide water for the exothermic reaction during self-sintering. The ratio between the water or hydrogen peroxide and water-soluble poly(ethylene oxide) resin (WSR) in the solution gel, and the gel's concentration in the paste/ink can be tuned or manipulated to make the exothermic reaction provide high enough temperature for the self-sintering, meanwhile the formation of oxides, metal oxyhydrides, and H₂ bubbles can be manipulated to minimize the volume of formed voids and remaining reactants after the self-sintering.

Water-soluble poly(ethylene oxide) solution gel may be a mixture of water (H₂O) and/or hydrogen peroxide (H₂O₂) and/or alcohol (70% isopropyl) and/or ammonia (10% ammonium hydroxide), and 1-30 wt % soluble poly(ethylene oxide) polymer e.g., having a general composition of 95% to 100% poly(ethylene oxide) and up to 5% fumed silica. Industrial water soluble resin such as POLYOX™ WSR N750 or POLYOX™ WSR 301 may be used.

Other water-soluble materials such as phosphorus oxoacid compound, halogen compound, gelatin, polyvinyl alcohol, polyvinyl acetal, polyvinylpyrrolidone (PVP), carrageenan, carboxylmethyl cellulose, hydroxylpropyl cellulose, may be used as additional additives. Other additives such as KOH, KCl, NaCl, HCl, Ba₂Cl₂, BiOCl, NaBH₄, NaMgH₃, Al(OH)₃ may be added to the water-soluble poly(ethylene oxide) solution gel to enhance the exothermic reaction (changing the reaction strength and temperature) and promote the self-sintering at relatively low temperatures.

To form a moisture sensitive TIM, a polymer matrix may be formed by combining 3-20 wt. % water-soluble resin and 0-10 wt. % fumed silica in a water or hydrogen peroxide or alcohol or other water-contained solvent solution.

Water Insoluble Resins

Water-insoluble resins (WIR) may be used for formulating electrically conductive and dielectric materials with long term chemical stability in a high humidity or wet environment. Water-insoluble resins may be a mixture of 91% isopropyl alcohol water solution and/or ammonium hydroxide and or NaOH/urea, and (65-100) wt % ETHOCEL™ Standard 200 Industrial Ethylcellulose (>98.0 cellulose, ethylether), (0-35) wt % soluble poly(ethylene oxide) polymer up to 3% fumed silica. ETHOCEL™ Standard 200. Industrial ethylcellulose can be used to fabricate TIMs with an optimal transparent matrix, and functions as (a) an adhesive to provide strength, viscosity, and rheology to alcohol solvent-based formulations of TIMs; (b) binder and rheology modifier (may be able to provide clean burn out or removal undesired constituents) in the dielectric TIMs; (c) surface coating for exposed surface of TIMs to provide waterproofing, toughness and flexibility.

To form a moisture insensitive TIM, a polymer matrix may be formed by combining 65-100 wt. % water-insoluble resin, 0-30 wt. % water-soluble resin, 0-10 wt. % fumed silica, and 0 to 5 wt. % potassium hydroxide in an alcohol or other solvent solution, such as acetone, ionic liquids, NaOH/urea, ammonium hydroxide, phosphoric acid, acetic acid, formic acid, pyridine, aromatic hydrocarbons, halogenated hydrocarbons, and ketones.

Additives

Other additives and solvents may be added to the water-soluble resin solution gel or water-insoluble resin solution gel, to adjust and obtain the desired rheological, wetting, healing, or stretching properties to the pastes/inks for different molding, patterning, and/or printing technologies. Other polymeric binders, such as acrylic, silicone, styrene, fluoroelastomers, or urethane backbones, may be added to help in homogeneous dispersion of the fillers and the Gallium based low melting point alloys (both liquid and solid) into the paste/ink, to hold the paste/ink components together upon solvent evaporation and also help bind the molded/printed patterns onto the substrate. In addition to water, other paste/ink solvents may be used to provide enhanced solubility to the water-soluble polymer or other polymeric binder and impart favorable viscosity, surface tension, and homogeneity. Other additives may be also included to further impart desired rheological, wetting, healing, or stretching properties to the inks. Additives in the form of surfactants, adhesion improvers, humectants, penetration promoters, and stabilizers are used to tailor the ink properties for specific applications.

Manufacturing Process

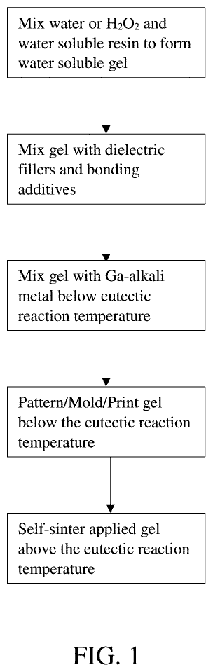

FIG. 1 is an illustrative flow chart illustrating an example of a process for making and using self-sintering dielectric thermal interface materials formulated through exothermic reaction and sensitive to water/moisture.

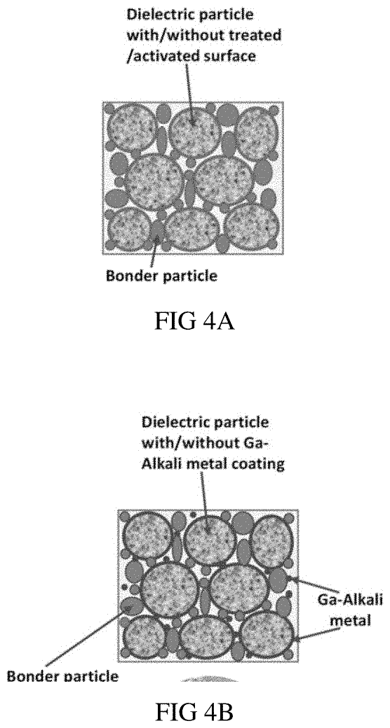

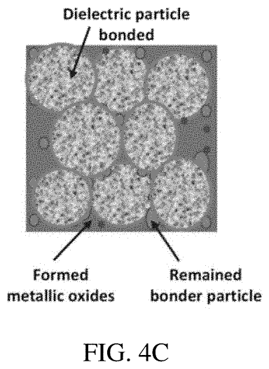

Water or hydrogen peroxide may be combined with a water soluble resin and mixed to form a water-soluble polymer gel. Fillers and bonding additives may be mixed in the water-soluble polymer gel. FIG. 4A depicts a water-soluble gel containing dielectric fillers and bonder particles. The gel is then mixed with gallium-alkali metal below the eutectic reaction temperature. FIG. 4B depicts a water-soluble gel containing dielectric fillers, bonder particles, and gallium-alkali metal. The constituents can be stably mixed and stored. The mixture can be molded, patterned, and/or printed below the gallium-alkali metal eutectic reaction temperature (˜26.8° C. for Ga—Al eutectic reaction) to avoid the exothermic reaction. The molded, patterned, and/or printed product may be self-sintered when the environmental temperature is above the gallium-alkali metal eutectic reaction temperature which triggers the exothermic reaction and liquid metal fusion. FIG. 4C depicts a self-sintered product. The relatively higher temperature (˜100° C. for example) can be used for the self-sintering to reduce the sintering time from about 1-3 hours (self-sintering at ˜30° C. for Ga—Al eutectic reaction) to several minutes or less for a 1-3 mm thick dielectric film, and even to seconds or less for a much thinner film on the order of 100 μm or less. The thinner the sample, the quicker the sintering. Different material constituents and the percentage of the concentrations can affect the sintering time.

### Example 1

Self-sintered dielectric thermal interface materials (sensitive to water/moisture) are formulated via the following process including an exothermic reaction. POLYOX™ WSR N750 powder, dielectric filler, and nickel silver binder powder are mixed with water to form a uniform gel mixture at room temperature. Gallium-aluminum metal (Ga-2 wt % Al₃Ti_{0.5}C for example) is added to the gel mixture and mixed under a controlled temperature of 15-20° C. The temperature of the paste and substrate materials is controlled to less than 20° C. prior to and during loading of paste mixture into the syringe of the printer. As an example, a 1-3 mm thick sample is molded or printed and maintained at room temperature for 0.1-0.3 hours for self-sintering. Room temperature is generally 30-35° C. These materials may be much thinner, such as on the order of 100 um or less.

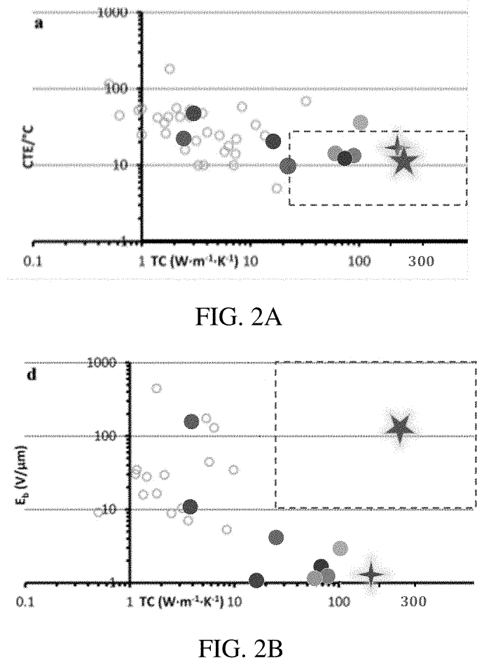

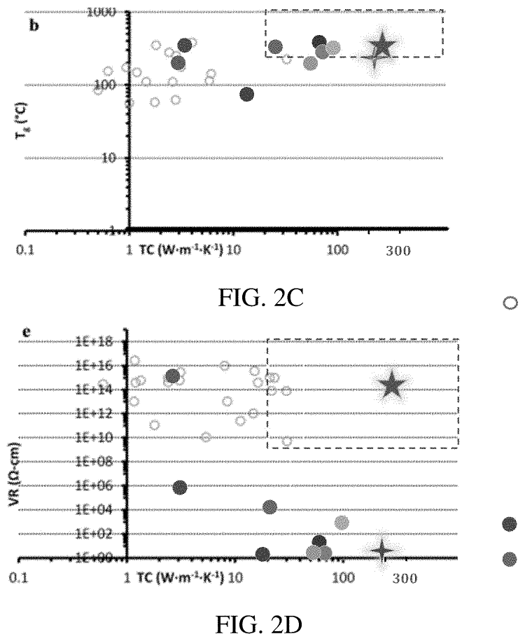

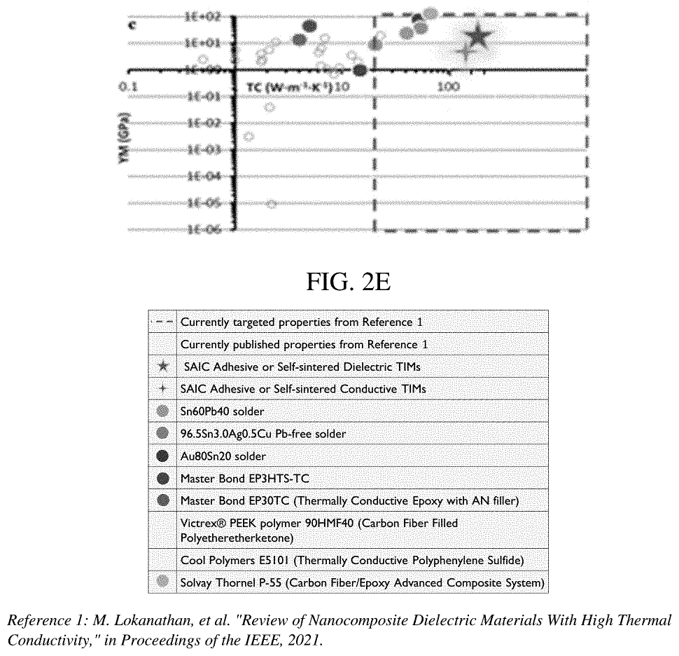

Self-sintered thermal interface materials were prepared in accordance with the above process and compared with the prior art. FIG. 2A depicts thermal expansion versus thermal conductivity of the self-sintered dielectric and conductive thermal interface materials. The elastic nature of the inventive TIMs enables them to conformably coat contact surfaces, while simultaneously minimizing thermal expansion stress when joining two contact surfaces. FIG. 2B depicts electric field strength versus thermal conductivity of the self-sintered dielectric and conductive thermal interface materials. This provides quantitative insight on how the dielectric properties of the invented TIMs surpass other leading materials in dielectric strength and voltage breakdown resistance. FIG. 2C depicts glass transition temperature versus thermal conductivity of the self-sintered dielectric and conductive thermal interface materials. This provides quantitative insight on how the thermal stability of the invented TIMs can be is on par with other leading materials. FIG. 2D depicts electrical resistivity versus thermal conductivity of the self-sintered dielectric and conductive thermal interface materials. This quantifies how the invented dielectric TIMs can be customized with high electrical resistivity equivalent to or surpassing other leading materials. FIG. 2E depicts Young's modulus versus thermal conductivity of the self-sintered dielectric and conductive thermal interface materials. This provides quantitative insight on how the mechanical properties of the invented TIMs can be tuned from flexible to highly rigid versus the static properties of other leading materials.

### Example 2

Eight samples were prepared in accordance with Tables V and VI below.

Table V depicts thermally conductive/electrically conductive TIMs.

TABLE V

| | | | | | Pull test- | |
|---|---|---|---|---|---|---|
| | Resin | Composite | Thermal | | bonding | |
| | Matrix | material | conductivity | Electrical | strength | Water |
| Sample | formulation | formulation | (W/m-K) | resistivity | on Cu | soluble |
| 1 | 15 wt. % WSR + | 35 wt. % [Resin | 91.77 | 0.3-50 | ~20 | Yes |
| | 5 wt. % Fumed | Matrix] + | | Ω/10 mm | lb/1 cm² | |
| | silica | 25 wt. % Ga + | | on the block | | |
| | water solution | 35 wt. % Ag | | sample | | |
| | | (9 μm flake) | | surface | | |
| 2 | 15 wt. % WSR + | 5 wt. % [Resin | 91.76 | 0.3-50 | >30 | No* |
| | 5 wt. % Fumed | Matrix] + | | Ω/10 mm | lb/1 cm² | |
| | silica + 80 wt. % | 25 wt. % Ga + | | on the block | (Cu foil | |
| | Alcohol solution | 35 wt. % Ag | | sample | broken, | |
| | | (9 μm flake) | | surface | sample not) | |
| 3 | 15 wt. % WIR + | 35 wt. % [Resin | 61.15 | 0 | ~1 | No |
| | 5 wt % Fumed | Matrix] + | (Rigid) | Ω/10 mm | lb/1 cm² | |
| | silica + 80 wt. % (70% | 25 wt. % Ga + | | on the block | | |
| | Isopropyl alcohol) | 35 wt. % Ag | | sample | | |
| | | (9 μm flake) | | surface | | |
| 8 | 15 wt. % WIR + | 35 wt. % [Resin | 117.20 | 0.02-0.03 | >25 | No |
| | 5 wt. % Fumed | Matrix] + | | Ω/10 mm | lb/1 cm² | |
| | silica + 80 wt. % (91% | 15 wt. % Ga + | | on the block | (Cu foil | |
| | Isopropyl alcohol) | 50 wt. % Ag | | sample | broken) | |
| | | (9 μm flake) | | surface | | |

*Softened in water but hardened after drying

Table VI depicts thermally conductive/dielectric TIMs.

TABLE VI

| | | | | | Pull test- | |
|---|---|---|---|---|---|---|
| | Resin | Composite | Thermal | | bonding | |
| | Matrix | material | conductivity | Electrical | strength | Water |
| Sample | formulation | formulation | (W/m-K) | resistivity | on Cu | soluble |
| 9 | 15 wt. % WIR + | 35 wt. % [Resin | 197.44 | >100,000 | ~20 | No |
| | 5 wt. % Fumed | Matrix] + 5 wt. % | | Ω/10 mm | lb/1 cm² | |
| | silica + 80 wt. % (91% | Ga + 5 wt. % Ag | | on the block | | |
| | Isopropyl alcohol) | (9 μm flake) + 30 | | sample | | |
| | | wt. % h-BN (3M | | surface | | |
| | | 012, 14 μm) + 20 | | | | |
| | | wt. % h-BN (3M | | | | |
| | | 500-3, 300 μm) | | | | |
| 4 | 15 wt. % WSR + | 40 wt. % [Resin | 162.1 | >100,000 | ~20 | Yes |
| | 5 wt. % Fumed | Matrix] + 5 wt. % | | Ω/10 mm | lb/1 cm² | |
| | silica | Ga + 5 wt. % Ag | | on the block | | |
| | water solution | flake (9 μm) + 30 | | sample | | |
| | | wt. % h-BN (3M | | surface | | |
| | | 012, 14 μm) + 20 | | | | |
| | | wt. % h-BN (3M | | | | |
| | | 500-3, 300 μm) | | | | |
| 5 | 15 wt. % WSR + | 40 wt. % [Resin | 185.5 | >100,000 | >22 | No* |
| | 5 wt. % Fumed | Matrix] + 5 wt. % | | Ω/10 mm | lb/1 cm² | |
| | silica + 80 wt. % | Ga + 5 wt. % Ag | | on the block | (Cu foil | |
| | Alcohol solution | flake(9 μm) + 30 | | sample | broken) | |
| | | wt. % h-BN (3M | | surface | | |
| | | 012, 14 μm) + 20 | | | | |
| | | wt. % h-BN (3M | | | | |
| | | 500-3, 300 μm) | | | | |
| 6 | 15 wt. % WIR + | 40 wt. % [Resin | 174.38 | >100,000 | >24 | No* |
| | 5 wt. % Fumed | Matrix] + 5 wt. % | | Ω/10 mm | lb/1 cm² | |
| | silica + 80 wt. % (70% | Ga + 5 wt. % Ag | | on the block | (Cu foil | |
| | Isopropyl alcohol) | flake(9 μm) + | | sample | broken) | |
| | | 50 wt % h-BN | | surface | | |
| | | (3M 075, 8 μm) | | | | |
| 7 | 15 wt. % WIR + | 40 wt. % [Resin | 197.06 | >100,000 | >21 | No* |
| | 5 wt. % Fumed | Matrix] + 5 wt. % | | Ω/10 mm | lb/1 cm² | |
| | silica + 80 wt. % (91% | Ga + 5 wt. % Ag | | on the block | (Cu foil | |
| | Isopropyl alcohol) + | flake (9 μm) + 30 | | sample | broken) | |
| | 5 wt % KOH solution | wt. % h-BN (3M | | surface | | |
| | | 075, 8 μm) + 20 | | | | |
| | | wt. % h- | | | | |
| | | BN(3M500-3, | | | | |
| | | 300 μm) | | | | |

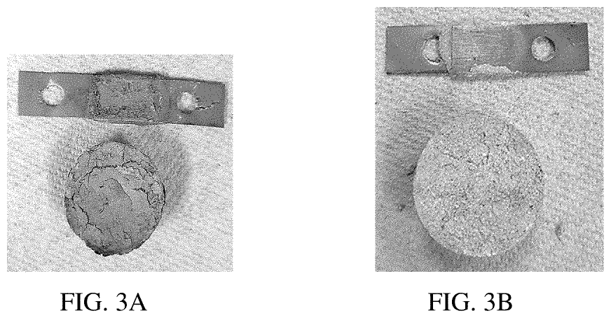

Both electrically conductive TIM Sample 8 and dielectric TIM Sample 9 were prepared with a water insoluble resin (WIR) matrix: 15 wt. % WIR+5 wt. % Fumed silica+80 wt. % (91% isopropyl alcohol) and tested. Two coupons of the electrically conductive TIM and three coupons of the dielectric TIM were molded and tested for thermal conductivity. FIG. 3A depicts self-sintered thermal interface material of Sample 8 in accordance with an aspect of the disclosure. FIG. 3B depicts self-sintered thermal interface material of Sample 9 in accordance with an aspect of the disclosure.

These samples were used to measure and evaluate the adhesion between the TIM and copper substrate, shear strength of the TIM, electrical and thermal conductivities.

Aspects of the present disclosure relate to formulation, process, and application of self-sintering thermal interface materials.

The self-sintered thermal interface materials can strongly adhere to many different substrates, such as metals or alloys (copper, aluminum, stainless steel, etc.), polymers (polyethylene terephthalate (PET), polyethylene naphthalate (PEN), polycarbonate (PC), polyethersulfone (PES), polyimide (PI) and polyarylate (PAR), and polydimethylsiloxane (PDMS) as stretchable substrate, etc.), glasses, ceramics, papers, and textile, etc.

Self-sintered thermal interface materials achieve thermal conductivities greater than 150 W/m-K versus leading industry materials that are nominally 60 W/m-K without elevated temperature sintering, optical/ultra-violet curing and/or pressure requirements for formation and interface bonding resulting in better performance, ease of manufacturing, and lower cost.

Self-sintered thermal interface materials can be tailored to provide extremely low thermal impedance, ultrahigh thermal conductivity, good conformability with minimum thermal expansion stress when joining two contact surfaces, adequate adhesion, controlled sensitivity to moisture and temperature changes for different service life applications, and doable manufacturability under ambient atmosphere.

Self-sintered thermal interface materials can be used for thermal management technologies to be used in different applications such as the LED lighting, photovoltaics, lasers, telecommunications equipment, automotive electronics, industrial computing, defense and aerospace electronics, consumer and mobile handheld electronics, medical electronics, wireless sensor networks, PCB testing equipment, energy harvesting storage equipment, as well as 5G or beyond technologies.

Based on the tunable concentration of the gallium-alkali metal constituent, some type of the self-sintered thermal interface materials can be used for anti-tamper and emergency temperature response like bringing an auxiliary cooling unit online.

Since self-sintered thermal interface materials do not require elevated temperature sintering, optical/ultra-violet curing and/or pressure for formation and interface bonding, they enable high performance thermal management in applications where the physical sensitivity or opaque nature of the component elements precluded conventional high performance thermal management solutions that do require elevated temperature sintering, optical/ultra-violet curing and/or pressure for formation and interface bonding. While not required, elevated temperature sintering, optical/ultra-violet curing and/or pressure for formation and interface bonding may further improve the properties of self-sintered materials.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

We claim:

1. A self-sintering thermal interface material comprising
a polymer matrix and a filler;
wherein the polymer matrix comprises a water or hydrogen peroxide solution comprising at least one water soluble resin and fumed silica;
wherein the filler comprises i) gallium-alkali metal or gallium metal and ii) one or more micro/nano-sized metallic fillers.

2. The self-sintering thermal interface material of claim 1 wherein the self-sintering thermal interface material self-sinters when a temperature is raised above the eutectic reaction temperature of the gallium-alkali metal or the melting point of the gallium metal.

3. The self-sintering thermal interface material of claim 1 wherein the water soluble resin comprises water-soluble poly(ethylene oxide) resin.

4. The self-sintering thermal interface material of claim 1 wherein the thermal interface material is electrically conductive, the polymer matrix comprises 3-20 wt. % water soluble resin and 0-10 wt. % fumed silica, and the filler comprises 5-35 wt. % gallium-alkali metal alloy or gallium metal and 30-95 wt. % micro/nano-sized metallic fillers.

5. The self-sintering thermal interface material of claim 1 wherein the thermal interface material is dielectric, the polymer matrix comprises 3-20 wt. % water soluble resin and 0-10 wt. % fumed silica, and the filler comprises 5-35 wt. % gallium-alkali metal alloy or gallium metal, 5-15 wt. % micro/nano-sized metallic fillers, and 10-90 wt. % dielectric fillers.

6. The self-sintering thermal interface material of claim 1 wherein the gallium-alkali metal is selected from the group consisting of Ga—Al, Ga—AlTiC, Ga—Al—Ti—B, Ga—Mg, Ga—In—Al, Ga—In—Sn—Al, Ga—Zn, Ga—Fe, Ga—Li, Ga—K, Ga—Ba, Ga—Ca, and Ga—Na.

7. The self-sintering thermal interface material of claim 6 wherein the gallium-alkali metal further comprises at least one selected from the group consisting of In, Sn, Ti, B, C, Ag, Cu, Fe, Si, Pb, Zn, Ni, Cr, Bi, and rare earth elements.

8. The self-sintering thermal interface material of claim 1 wherein the micro/nano-sized metallic fillers include at least one selected from the group consisting of BN, AN, Al₂O₃, BeO, SiC, Si, diamond, and hybrids thereof.

9. The self-sintering thermal interface material of claim 1 wherein the micro/nano-sized metallic fillers include at least one selected from the group consisting of silver, copper, aluminum, gold, zinc, nickel and alloys thereof.

10. The self-sintering thermal interface material of claim 1 wherein the filler comprises gallium alkali metal.

11. The self-sintering thermal interface material of claim 1 wherein the filler comprises gallium metal.

12. The self-sintering thermal interface material of claim 1 further comprising at least one selected from the group consisting of KOH, KCl, NaCl, HCl, Ba₂Cl₂, BiOCl, NaBH₄, NaMgH₃, Al(OH)₃.

13. A method of forming a self-sintering thermal interface material comprising:
mixing a water-soluble resin and fumed silica with water, hydrogen peroxide, or water-contained ammonia or alcohol to form a water absorbing gel; and
mixing the water absorbing gel with micro/nano-sized metallic fillers and gallium-alkali metal or gallium metal, at a temperature below the eutectic reaction temperature of the gallium-alkali metal or below the melting point of the gallium metal, to form a mixture.

14. The method of claim 13 further comprising applying the mixture to a substrate and then raising the temperature above the eutectic reaction temperature of the gallium-alkali metal or above the melting point of the gallium metal until the mixture self-sinters.

15. A self-sintering thermal interface material comprising
a polymer matrix and a filler;
wherein the polymer matrix comprises an alcohol solution comprising at least one water insoluble resin and fumed silica;
wherein the filler comprises i) gallium-alkali metal or gallium metal and ii) one or more micro/nano-sized metallic fillers.

16. The self-sintering thermal interface material of claim 15 wherein the self-sintering thermal interface material self-sinters when a temperature is raised above the eutectic reaction temperature of the gallium-alkali metal or the below the melting point of the gallium metal.

17. The self-sintering thermal interface material of claim 15 wherein the water insoluble resin comprises ethyl cellulose.

18. The self-sintering thermal interface material of claim 15 wherein the alcohol solution is 70% isopropyl alcohol water solution or 91% isopropyl alcohol water solution.

19. The self-sintering thermal interface material of claim 15 further comprising a water-soluble resin.

20. The self-sintering thermal interface material of claim 15 wherein the thermal interface material is electrically conductive, the polymer matrix comprises 65-100 wt. % water-insoluble resin, 0-30 wt. % water soluble resin, and 0-10 wt. % fumed silica, and the filler comprises 5-35 wt. % gallium-alkali metal or gallium metal and 30-90 wt. % micro/nano-sized metallic fillers.

21. The self-sintering thermal interface material of claim 15 wherein the thermal interface material is dielectric, the polymer matrix comprises 3-20 wt. % water soluble resin and 0-10 wt. % fumed silica, and the filler comprises 5-35 wt. % gallium-alkali metal or gallium metal, 5-15 wt. % micro/nano-sized metallic fillers, and 10-90 wt. % dielectric fillers.

22. The self-sintering thermal interface material of claim 21 wherein the gallium-alkali metal is selected from the group consisting of Ga—Al, Ga—AlTiC, Ga—Al—Ti—B, Ga—Mg, Ga—In—Al, Ga—In—Sn—Al, Ga—Zn, Ga—Fe, Ga—Li, Ga—K, Ga—Ba, Ga—Ca, and Ga—Na.

23. The self-sintering thermal interface material of claim 22 wherein the gallium-alkali metal further comprises at least one selected from the group consisting of In, Sn, Ti, B, C, Ag, Cu, Fe, Si, Pb, Zn, Ni, Cr, Bi, and rare earth elements.

24. The self-sintering thermal interface material of claim 21 wherein the micro/nano-sized metallic fillers include at least one selected from the group consisting of BN, AN, Al₂O₃, BeO, SiC, Si, diamond, and hybrids thereof.

25. The self-sintering thermal interface material of claim 21 wherein the micro/nano-sized metallic fillers include at least one selected from the group consisting of silver, copper, aluminum, gold, zinc, nickel and alloys thereof.

26. The self-sintering thermal interface material of claim 21 wherein the filler comprises gallium alkali metal.

27. The self-sintering thermal interface material of claim 21 wherein the filler comprises gallium metal.

28. The self-sintering thermal interface material of claim 21 further comprising at least one selected from the group consisting of KOH, KCl, NaCl, HCl, Ba₂Cl₂, BiOCl, NaBH₄, NaMgH₃, Al(OH)₃.

29. A method of forming a self-sintering thermal interface material comprising:
mixing a water-insoluble resin and fumed silica, dielectric filler, and micro/nano-sized metallic fillers with an alcohol solution or an equivalent solvent such as acetone, ionic liquids, NaOH/urea, ammonium hydroxide, phosphoric acid, acetic acid, formic acid, pyridine, aromatic hydrocarbons, halogenated hydrocarbons, and ketones; and
mixing the alcohol solution with micro/nano-sized metallic fillers and gallium-alkali metal or gallium metal, at a temperature below the eutectic reaction temperature of the gallium-alkali metal or below the melting point of the gallium metal, to form a mixture.

30. The method of claim 29 further comprising applying the mixture and then raising the temperature above the eutectic reaction temperature of the gallium-alkali metal or above the melting point of the gallium metal until the mixture self-sinters.
